(19) United States
(12) Patent Application Publication
(10) Pub. No.: US 2003/0047169 A1
(43) Pub. Date: Mar. 13, 2003

(54) Pressure-regulating arrangement

(75) Inventors: Werner Buse, Kaarst (DE); Albert Denne, Meerbusch (DE)

Correspondence Address: JULIAN H. COHEN, Ladas & Parry, 26 West 61st Street, New York, NY, 10023, US

(73) Assignee: PIERBURG GMBH

(21) Appl. No.: 10/236,765

(22) Filed: Sep. 6, 2002

(30) Foreign Application Priority Data
Sep. 7, 2001 (DE) 101 43 891.5

(51) Int. Cl. F02M 1/00

(52) U.S. Cl. 123/457; 123/514

(57) ABSTRACT

A pressure-regulating apparatus for supply of fuel from a fuel pump in a fuel tank via a fuel line to a distributor of an internal combustion engine, a pressure-regulating valve being arranged in the fuel tank, to return fuel from the fuel line, when the valve is opened, to the fuel tank. The pressure-regulating valve has first and second chambers separated in a liquid-tight manner by a membrane which actuates a valve-closing member. The first chamber has at least one inlet connected to the fuel line by a first branch line and at least one outlet which leads into the fuel tank. The second chamber contains a spring which biasses the valve-closing member to a closed position. The second chamber of the pressure-regulating valve has a second inlet connected to the fuel line via a second branch line, and a switch device in is provided the second branch line to establish different pressure levels in the second chamber. In order to provide continuous pressure regulation, the switch device can be a pulse-width modulated electrohydraulic converter which is connected to a pressure sensor on the fuel distributor.

### FIELD OF THE INVENTION

The invention relates to a pressure-regulating apparatus for the supply of fuel from a fuel pump arranged in a fuel tank via a fuel line to a fuel distributor of an internal combustion engine. The pressure regulating apparatus comprises a pressure-regulating valve arranged in the fuel tank to return fuel to the fuel tank when the valve is opened. The pressure-regulating valve has first and second chambers, which are separated from one another in a liquid-tight manner by a membrane actuating a valve-closing member, the first chamber having at least one inlet opening, which is connected to the fuel line by a first branch line and at least one outlet opening, which leads into the fuel tank, the second chamber including a spring that biasses the valve-closing member in the closing direction.

### BACKGROUND AND PRIOR ART

Such a pressure-regulating arrangement is disclosed in French Patent Application 2,730,526. This application discloses a so-called non-return fuel system, which provides only one connection line from the fuel tank with the fuel pump with the fuel distributor and the engine. By dispensing with a so-called return line from the engine to the fuel tank, this fuel system is particularly suitable for fulfilling strict emissions regulations. In order to assure a constant fuel pressure with different throughputs in the fuel line, FR 2,730,526 provides a first pressure regulator arranged in the tank and a second pressure regulator outside the tank in the fuel line just in front of the fuel distributor. Excess fuel can be conducted back into the fuel tank by means of the first pressure regulator, in order to draw off fuel at a constant pressure from the tank when the flow quantities are different. The second pressure regulator has the task of equilibrating the pressure losses within the fuel line and assuring that a constant pressure is also present when engine loads vary. Although this fuel system only has one fuel line leading to the fuel distributor, it has the disadvantage that an additional regulator must be provided i.e., the second pressure regulator. This arrangement in turn leads to the requirement for special connections and sealing means to fulfill strict emissions regulations.

### SUMMARY OF THE INVENTION

An object of the present invention is to provide pressure regulating apparatus which overcomes the problems described above.

This object is achieved according to the invention in that the second chamber of the pressure-regulating valve has a second inlet, which is connected to the fuel line by a second branch line containing a switch means such that different adjusted pressure levels can be provided in the second chamber.

It is now possible, according to the invention, to arrange the components related to emission in the fuel tank, so that a non-return fuel system can be obtained with a continuous fuel line. The pressure-regulating apparatus according to the invention thus assures that loses in the fuel line that are caused by the flow are equilibrated and the fuel pressure can be adapted to the different engine loads. In a particularly simple embodiment, the second chamber has a second outlet. A first nozzle with a diameter D1 is arranged in the second inlet and a second nozzle with a diameter D2 is arranged in the second outlet, wherein diameter D2 is greater than diameter D1 and the nozzles are so dimensioned that the drop in pressure in the two nozzles corresponds to the total pressure of the fuel pump, the switch means being a 2/2-way valve. In the second outlet, however, a pressure relief valve may be arranged, which opens when a pressure increase is developed in the second chamber. In this case the switching means is a 3/2-way valve.

For a desired continuously adjustable pressure regulation, the switch means is a pulse-width modulated electrohydraulic converter, which makes possible a continuous adjustment of the pressure level in the second chamber.

In addition, a pressure sensor can be provided in the fuel distributor, which is connected to the electrohydraulic converter by means of a control element.

### BRIEF DESCRIPTION OF THE FIGURES OF THE DRAWINGS

FIG. 1 diagrammatically illustrates a first of embodiment of a pressure-regulating apparatus according to the invention.

FIG. 2 shows a second embodiment of the pressure-regulating apparatus according to the invention.

FIG. 3 shows a third embodiment of the pressure-regulating apparatus according to the invention.

### DETAILED DESCRIPTION

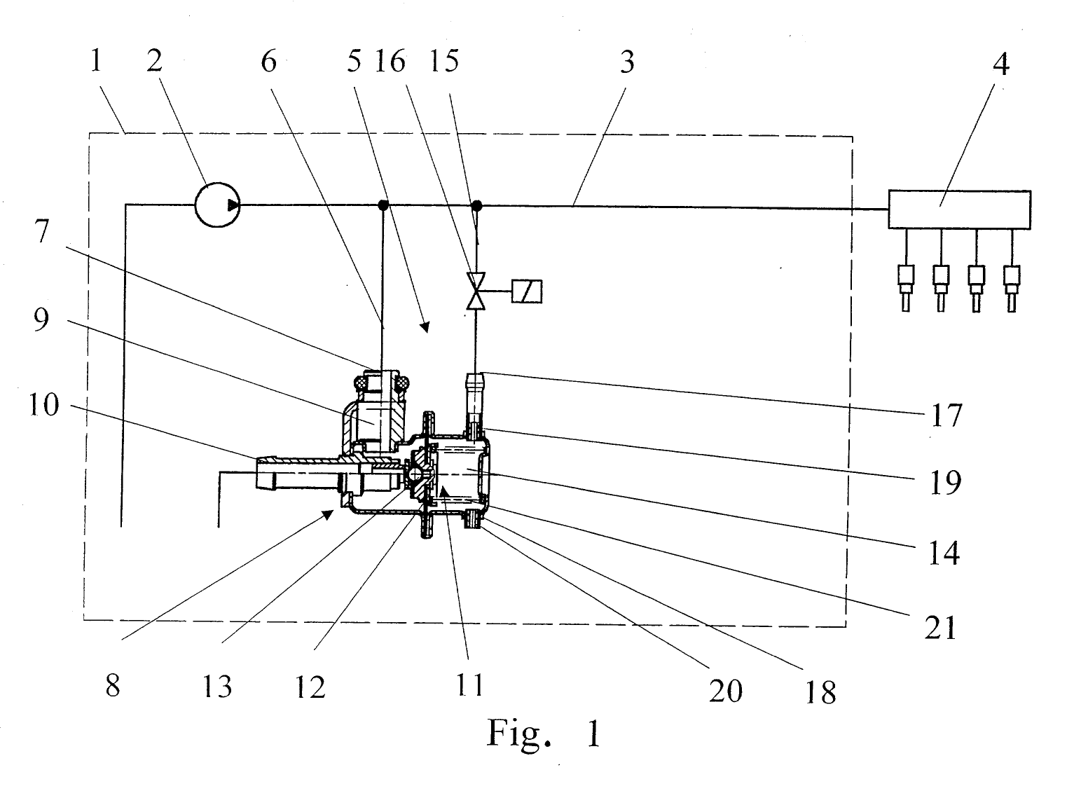

FIG. 1 shows schematically the flow path of fuel to an internal combustion engine (not shown in detail), wherein fuel is conducted from a fuel tank 1 by a pump 2 through a fuel line 3 to a fuel distributor 4. In order to assure that the fuel is supplied at a defined pressure to the fuel distributor, in addition to pump 2, a pressure-regulating apparatus 5 is provided in fuel tank 1. The pressure-regulating apparatus 5 is designed according to the invention, to arrange components relevant to fuel emission in tank 1, wherein only one fuel line 3 extends outside the tank and conveys the fuel to the fuel distributor 4. A first branch line 6 is connected to fuel line 3 and extends to a first inlet 7 of a pressure-regulating valve 8. If the pressure-regulating valve 8 is in an open position, fuel is introduced via branch line 6 and inlet 7 into a first chamber 9 of valve 8 and returned to fuel tank 1 via the outlet 10. A closing means 11 of the pressure-regulating valve 8 is comprised of a valve-closing member 13 arranged on a membrane 12 which sealingly separates the first chamber 9 from a second chamber 14, and moves the valve-closing member into an open position, if the pressure in the first chamber 9, produces a force that is greater than the force produced in the second chamber 14.

In addition, the pressure-regulating apparatus 5 according to the invention has a second branch line 15 containing a switch means 16, which leads to a second inlet 17 of the pressure-regulating valve 8. Fuel can be introduced into the second chamber 14 by means of the second inlet 17. In addition, in the present embodiment, pressure-regulating valve 8 has another second outlet 18. A nozzle 19 is arranged in the inlet 17 and a nozzle 20 is arranged in the outlet opening 18. In order to be able to produce a defined drop in pressure in the two nozzles, nozzle 20 is designed with a diameter D2, which is greater than the diameter D1 of nozzle 19. In addition, a spring element 21 is provided in the second chamber 14, which biasses valve-closing member 11 in the closing direction. The switch means 16 in the present case is comprised of a simple 2/2-way valve.

The pressure-regulating apparatus 5 according to FIG. 1 operates as follows:

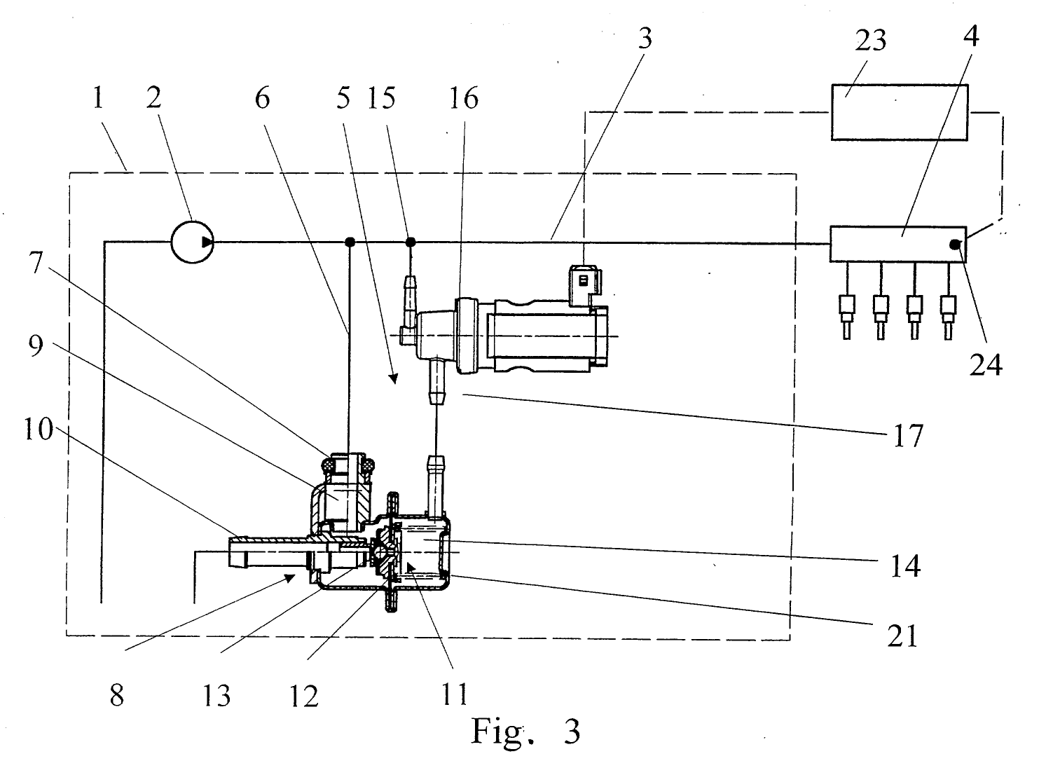

In a first adjustment of the pressure-regulating apparatus 5, a final pressure of approximately 4 bars will be produced in the fuel line 3. Particular losses in the line or high engine loads are not present in this operating state. Current is not supplied to electromagnetic 2/2-way valve 5 in this case, so that atmospheric pressure of 1 bar is present in the second chamber 14 and only the spring force acts on closing member 11. The spring force is adjusted such that closing member 11 opens when a pressure of more than 4 bars is present in the first chamber whereupon fuel is returned to the fuel tank via outlet 10. If a higher throughput in fuel line 3 is necessary due to a higher engine load or if, there are line losses, this can be determined, for example, by a pressure sensor 24 (FIG. 3) arranged on the fuel distributor 4 and switch means 16 is opened, and fuel can flow via the second branch line 15 to the second inlet opening 17 and into the second chamber 14, wherein a drop in pressure of ΔP 4 bars is produced by the first nozzle 19, which corresponds to the base pressure. A pressure drop of ΔP 1 bar is produced by the nozzle 20, and this pressure difference corresponds to the additional pressure that can be switched on. In the present embodiment, this means that the valve-closing member 13 only opens at a pressure greater than 5 bars in the first chamber 9. By this simple constructive means, it is thus possible to rapidly adapt the pressure provided for the fuel distributor. It should also be noted once more that nozzles 19, 20 are dimensioned so that the sum of the pressure drops at nozzles 19, 20 corresponds to the total pressure of the pump. In particular, the pressure drop at nozzle 19 corresponds to the base pressure of the pressure regulating apparatus 5 and the pressure drop at nozzle 20 corresponds to the additional pressure, which is required with elevated line losses or with a very high engine load. The rate of pressure adjustment is dependent on the dead volume of the regulation segment and the size of the nozzles. Large nozzles increase the rate of adjustment, but this also means a greater loss of volume of fuel pump 2. And since both nozzles are subjected to the same laws of flow, the additional pressure is not influenced by marginal effects, such as fuel viscosity, fuel temperature or the like. It should be clear that the nozzles in the present embodiment are only shown schematically, and that needle nozzles or the like may also be used.

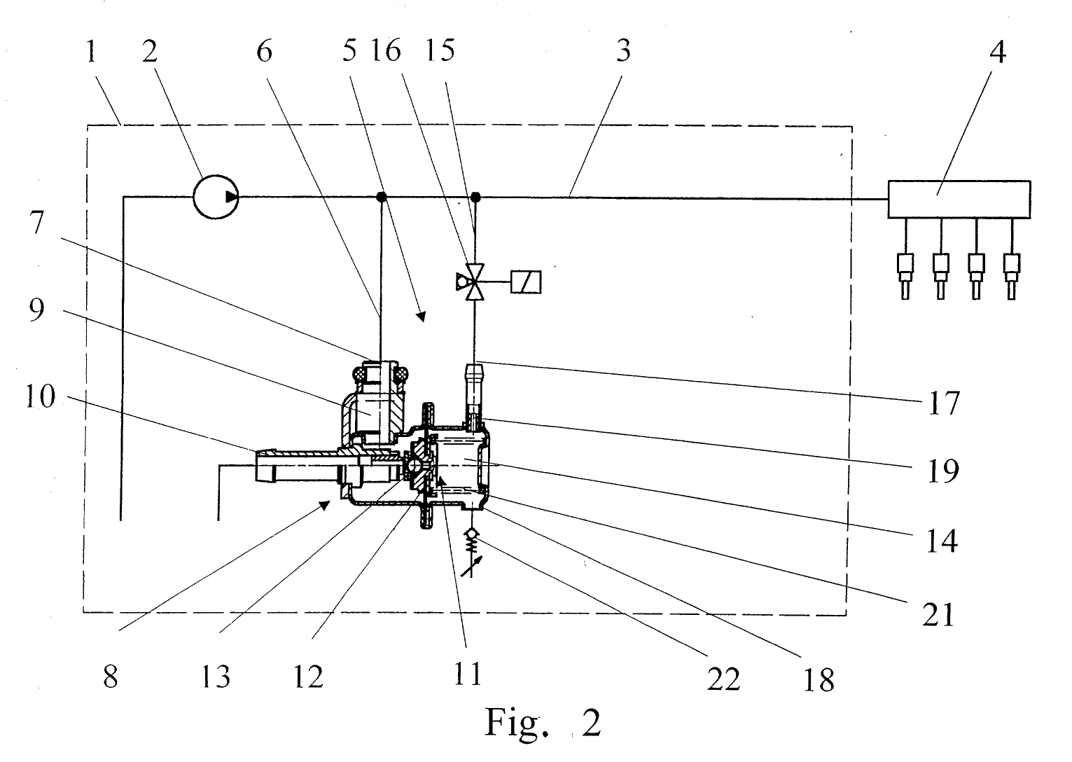

Another embodiment of the pressure-regulating apparatus 5 according to the invention is shown in FIG. 2. Here, instead of nozzle 20, a pressure-relief valve 22 is arranged in the second outlet opening 18. The pressure-relief valve 22 is also designed so that it opens at a pressure of 5 bars. Since the connection with the atmosphere of the second chamber is no longer obtained via the outlet 18, a 3/2-way valve is utilized in the present embodiment of the switch means 16. A pressure adjustment from base pressure to elevated pressure is conducted more rapidly in this embodiment, since volume is not lost due to the pressure-relief valve 22 during the pressure increase process. In addition, the pressure-relief valve 22 permits an accurate adjustment of the additional pressure.

In order to make possible a continuous adaptation of the pressure, reference is made to FIG. 3 wherein, the switch means is designed as a pulse-width-modulated electrohydraulic converter 16. The second chamber 14 in this case does not have a second outlet nor is nozzle 19 provided in the inlet 17. A pressure adjustment in the second chamber 14 can be obtained in the known way by the pulse-width modulated electrohydraulic converter 16. For this purpose, converter 16 is controlled by a control device 23, which is connected to pressure sensor 24 arranged in the distributor 4.

Although the invention is disclosed with reference to particular embodiments thereof, it will become apparent to those skilled in the art that numerous modifications and variations can be made which will fall within the scope and spirit of the invention as defined by the attached claims.

What is claimed is:

1. A pressure-regulating apparatus for supply of fuel from a fuel pump arranged in a fuel tank through a fuel line to a fuel distributor of an internal combustion engine, said apparatus comprising a pressure-regulating valve arranged in the fuel tank, to return fuel from the fuel line, when the valve is opened, back to the fuel tank, said pressure-regulating valve having first and second chambers separated from one another in a liquid-tight manner by a membrane which actuates a valve-closing member, said first chamber having at least one inlet connected to the fuel line by a first branch line and at least one outlet, which leads into the fuel tank, said second chamber including a spring which biasses said valve-closing member in a closing direction, said second chamber having a second inlet connected to the fuel line by a second branch line and a switch means in said second branch line for providing different pressure levels in said second chamber.

2. The pressure-regulating apparatus according to claim 1, wherein said second chamber has a second outlet and a first nozzle with a diameter D1 arranged in the second inlet.

3. The pressure-regulating apparatus according to claim 2, further comprising a second nozzle with a diameter D2 arranged in the second outlet, said diameter D2 being greater than diameter D1, said first and second nozzles being dimensioned such that a drop in pressure in the first and second nozzles corresponds to a total pressure of said fuel pump, said switching means comprising a 2/2-way valve.

4. The pressure-regulating arrangement according to claim 2, further comprising a pressure relief valve arranged in the second outlet to open in response to a pressure increase in the second chamber, said switching means comprising a 3/2-way valve.

5. The pressure-regulating arrangement according to claim 1, wherein said switching means comprises a pulse-width modulated electrohydraulic converter providing continuous adjustment of pressure in the second chamber.

6. The pressure-regulating arrangement according to claim 5, further comprising a pressure sensor in said distributor connected to said electrohydraulic converter by a control element.
